(19) United States
(12) Patent Application Publication
(10) Pub. No.: US 2022/0290801 A1
(43) Pub. Date: Sep. 15, 2022

(54) SUPPORT

(71) Applicant: Spartan Boss Ltd, Southwater (GB)

(72) Inventor: Robert David Gearing, Hartfield (GB)

(73) Assignee: Spartan Boss Ltd, Southwater (GB)

(21) Appl. No.: 17/198,850

(22) Filed: Mar. 11, 2021

(51) Int. Cl. F16M 11/14; F41A 23/12

(52) U.S. Cl. CPC F16M 11/14; F41A 23/12; F16M 2200/022

(57) ABSTRACT

The disclosure relates to the field of supporting devices and objects with tripods. In particular though not exclusively the invention relates to a tripod assembly comprising a tripod chassis body which is supportable above a surface by a plurality of tripod legs which are arranged, in use, below the chassis body, the chassis body defining a central aperture between the tripod legs, a functional module which fits in the central aperture, and locking means for locking the functional module, which has been located in the central aperture. In this way a number of functional modules can be used with a tripod to support a variety of objects such as firearms, photographic devices, or payloads. The disclosure also relates to a tripod central column according to the preceding claim including means for containing a plurality of tool components.

### FIELD OF THE INVENTION

This invention relates to the field of supports for objects and in particular, but not exclusively, to supporting objects or devices such as firearms, such as rifles, and photo- or videography equipment, by means of supports such as tripods.

### BACKGROUND

A variety of supports, such as bipods are known for stably supporting firearms. Traditionally, shooters have shot firearms, especially rifles, from stable positions on a range or in the field using a bipod to support the firearm, in a prone position, or from a bench rest. However, such bench rests are not readily portable, generally being restricted to ranges rather than practical shooting situations in the field. More recently, tripods have been used extensively for supporting firearms in practical shooting situations such as when hunting. In particular, use has been made of photographic tripods for stably supporting firearms for precision rifle shooting and also in hunting, as such photographic tripods may be relatively light and sturdy, as well as being readily portable. Typically, such tripods comprise a tripod assembly including at least one of: an optional tripod head unit (e.g., of a ball head, pistol grip, gimbal or geared head design) which ordinarily supports a photographic device such as a camera, three extendable tripod legs, a tripod chassis (or “spider”) which connects the legs and also supports the head. Applicant's DAVROS™ head system, which is the subject of U.S. Pat. No. 10,808,880, is another type of head unit which can be mounted on a tripod, through a conventional photographic screw coupling on the tripod. The DAVROS™ head system, which includes means for engaging a firearm such as a rifle in the form of a spigot which cooperates with an element mounted or fixed with the firearm can be used to stably support the firearm on a connected tripod.

There is a need for an alternative tripod chassis.

### SUMMARY OF THE DISCLOSURE

According to one aspect of the disclosure there is provided a tripod assembly according to claim 1.

There is also provided a tripod assembly comprising:
a. a tripod chassis body which is supportable above a surface by a plurality of tripod legs which are arranged, in use, below the chassis body, the chassis body defining a central aperture between the tripod legs,
b. one of a plurality of functional modules having a body functional module which fits in the central aperture, and
c. locking means for locking the functional module, which has been located in the central aperture in which the functional module fitted in the aperture can be replaced by another functional module from the plurality of functional modules.

The aperture may be circular. In such an embodiment the functional module may have a circular portion which is received within the circular aperture.

The functional module body may include a peripheral rim for inhibiting movement of the functional module through the central aperture.

The functional module may be arranged to engage with the locking means.

In another embodiment, the functional module may include an object engagement element such as a screw or spigot.

In one embodiment, the functional module defines a flat upper surface, and includes an object engagement element such as a photographic standard threaded screw or spigot.

The functional module may include a ball element. The ball element may be retained in a specific orientation, by locking means. The ball element may include or connect to an object engagement element, such as a spigot.

The object engagement element may include a magnet or magnetically engage the object, or an element mounted on the object.

In another embodiment, the functional module comprises a central column containing or otherwise holding at least one tool component such as a tool bit or head.

In another embodiment the functional module comprises a lifting device. For example, the lifting device may include a block and tackle.

A tripod assembly may include an insert arranged between the tripod chassis and the functional module.

According to another aspect of the disclosure there is provided a tripod chassis for use in a tripod chassis assembly, the tripod chassis comprising:

A tripod chassis for use in a tripod, the tripod chassis comprising:
a. a body which is supportable by a plurality of tripod legs which are arranged, in use, below the body, the body defining a central aperture for receiving a selected functional module in use; and
b. at least one locking means for locking the selected functional module which has been located in the central aperture to inhibit rotational and/or translational movement.
The locking means may inhibit rotational and translational movement of a functional module arranged in the central aperture. Preferably two or more locking means are provided by the chassis for inhibiting rotational and translational movement of a functional module arranged in the central aperture.
The central aperture is preferably circular and dimensioned to receive a correspondingly shaped functional module body.

According to another aspect of the disclosure there is provided a tripod comprising a tripod chassis or a tripod assembly as disclosed above.

According to another aspect of the disclosure there is provided a combination of a tripod and a tripod head unit selected from the group consisting of a standard ball head, a fluid head unit, and a head unit according to U.S. Pat. No. 10,808,880. The combination may further include a firearm.

According to another aspect of the disclosure there is provide a modular system comprising a tripod chassis according to the disclosure and a least one of items selected from the group consisting of at least one tripod leg, and a functional module as described herein. In such a modular system a functional module may comprise a ball element, a flat upper surface, a lifting device, or a tripod central column including at least one tool component.

According to another aspect of the disclosure there is provided a tripod central column which provides a support or container for at least one tool component, such as a screwdriver or hex tip bit, or a screwdriver or hex driver tip. Preferably, the central column supports or contains a selection of such tool components.

This aspect of the disclosure also provides a combination of a tripod central column and at least one tool component, such as the tool components mentioned above. Preferably, the combination includes a selection of tool components such as a plurality of screwdriver or hex tip bits, or screwdrivers or hex tip drivers.

Tools are conveniently carried with the tripod, or separately from the tripod (in that the central column including the at least one tool component may be carried by itself irrespective of the rest of the tripod)

Thus, this aspect of the disclosure provides a tripod assembly comprising a chassis and three legs depending therefrom, and a tripod central column which provides a support or container for at least one tool component.

### BRIEF DESCRIPTION OF THE DRAWINGS

Tripod chassis, tripod assemblies and combinations of such supports and firearms in accordance with the disclosure will now be described, by way of example only, with reference to the accompanying drawings, FIGS. 1 to 6, in which:

FIG. 1 is a perspective view of a tripod chassis in accordance with the disclosure.

FIG. 2 is a perspective view of an insert for use with the tripod chassis of FIG. 1 in another condition;

FIG. 3 is a perspective view of a flat plate-type functional module for use with the tripod chassis of FIG. 1;

FIG. 3A is a perspective view of a tripod assembly in accordance with the disclosure including the functional module of FIG. 3;

FIG. 4 is a perspective view of a ball head-type functional module in accordance with the disclosure;

FIG. 4A is a perspective view of a tripod assembly in accordance with the disclosure including the functional module of FIG. 4;

FIG. 5 is a perspective view of a central column tool box-type functional module in a functional condition and a tool component;

FIG. 5A is a perspective view the central column tool box-type functional module of FIG. 5 in a disassembled condition;

FIG. 5B is a perspective view of a tripod assembly in accordance with the disclosure, comprising an alternative tripod chassis, including a central column toolbox-type functional module of FIG. 5 in an assembled condition; and

FIG. 6 is a view of a combination of a tripod assembly and a firearm in accordance with the disclosure.

### DESCRIPTION

A Tripod Chassis and Insert

A tripod chassis 10 in accordance with the disclosure is shown in FIG. 1. The tripod chassis comprises a sturdy but relatively light tri-lobed cast aluminium body 12, which defines a substantially circular central aperture 14 for receiving a selected functional module as described further below. The side wall of the central aperture 14 defines a gap G1 which extends to the outer surface of the body 12. A horizontal bore 15 is defined through the body 12 from the outer surface to the inner wall between two of the lobes. The bore 15 is dimensioned to receive a resiliently biased locking pin (not shown), which normally extends into the circular aperture 14 to engage a selected functional module in the aperture, unless manually retracted by a user, and forms a locking means. Optionally the locking pin could be deflected by the functional module as it is inserted in the circular aperture 14, and then becomes biased against the recess of the functional module body. Other types of locking means are contemplated, such a screw which can be screwed through an aperture in the body to engage with a side of a selected functional module in the circular aperture. Each lobe includes a pivot point P1, P2 and P3 respectively for fitting a tripod leg (not shown) in conventional manner.

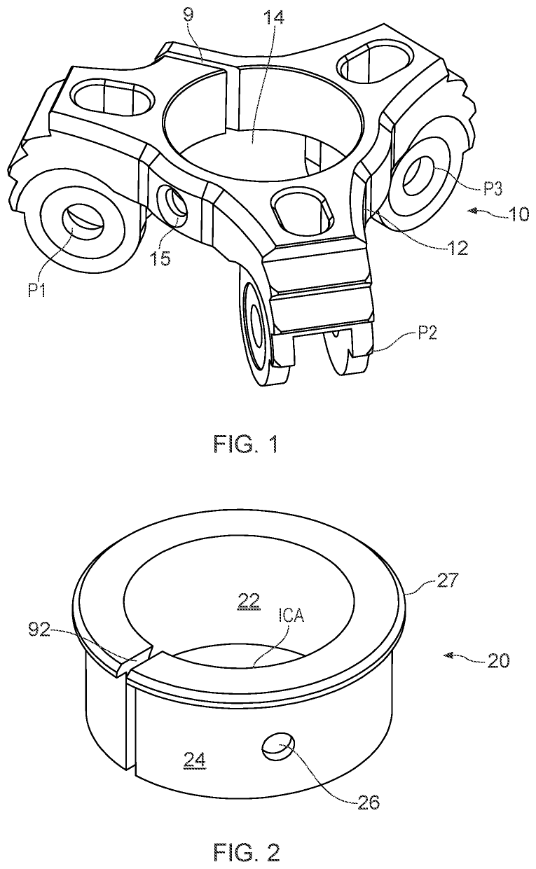

A substantially circular plastics material insert 20, which is optionally for use with a tripod chassis, is shown in FIG. 2. The insert 20, defines its own substantially circular aperture ICA. The insert 20 is sized to fit in the substantially circular central aperture 14 of the tripod chassis 10. The wall 22 of the insert 20 defines another gap G2 which extends to the outer wall of the 24 of the insert 20. The outer wall 24 also defines a recess 26, and a peripheral rim 27. In use the inset 20 is placed in the central aperture 14 of the tripod chassis 10 to reduce wear between the tripod chassis and any modules in the aperture ICA and therefore within the central aperture 14. The rim 27 stops the insert from falling through the central aperture 14 of the chassis 10. The recess 26 is dimensioned to receive a locking element, described below. Although a circular recess 26 is shown, the recess could be in the form of a slot to enhance engagement with the locking element. The use of an insert to reduce wear between a tripod chassis and a functional module as described in a tripod assembly in accordance with the disclosure is optional. The tripod chassis and/or a functional module could be formed from low wear materials.

A Tripod Assembly Including a Flat Plate-Type Functional Module

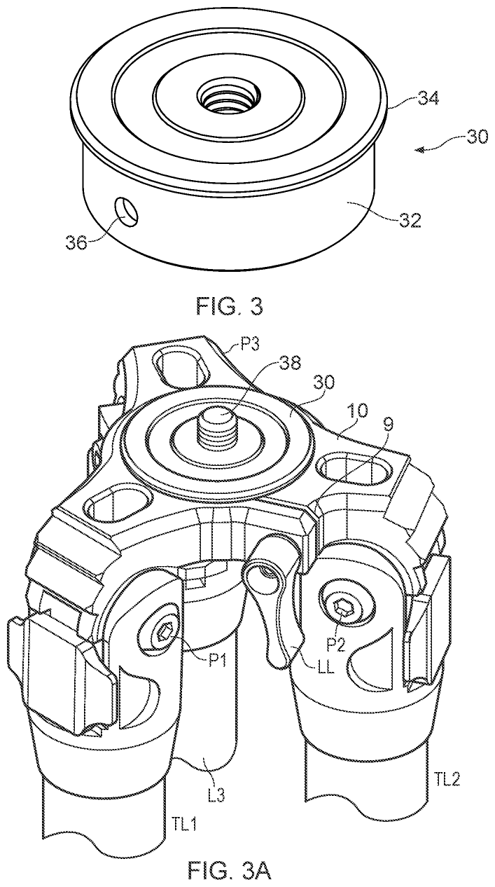

A flat plate-type functional module 30 is shown partially disassembled in FIG. 3 and complete in FIG. 3A, fitted in a tripod chassis. The flat plate-type functional module 30 comprises a circular body 32 having a peripheral upper rim 34. The outer wall of the body defines a recess 36. The recess 36 may be elongate to improve engagement. A central threaded bore is provided in the upper part of the body 32 which is threaded to take a conventional photographic threaded screw 38 for fitting a camera, scope or other device i.e., it has a ⅜-16 UNC or ¼-20 UNC thread.

In use, the functional module 30 is fitted in the central aperture 14 of tripod chassis 10. The proximal tip of the resiliently biased locking pin (obscured in FIG. 3A) engages with the recess 36 to inhibit translational or rotational movement of the functional module 30 when inserted in the central aperture and has to be retracted manually by a user to allow the functional module to be inserted in the central aperture. A locking lever LL is provided which can be operated by a user to close the gap G1 further or alternatively inhibiting withdrawal (i.e., translational movement) or rotation (i.e., rotational movement) of the module 30. As can be seen in FIG. 3A, the tripod chassis is pivotally connected via pivot points P1-3 to tripod legs TL1-3 which depend below the chassis 10—conventional manner to complete a tripod assembly.

A Tripod Assembly Including a Ball Head-Type Functional Module

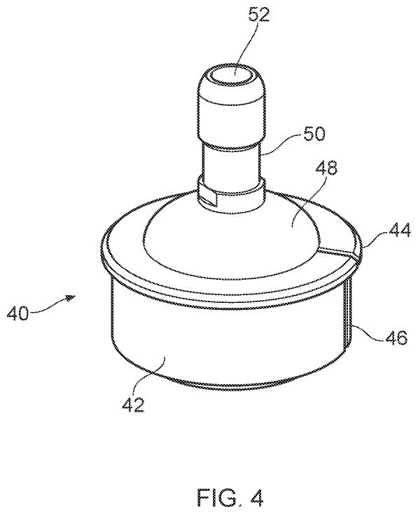

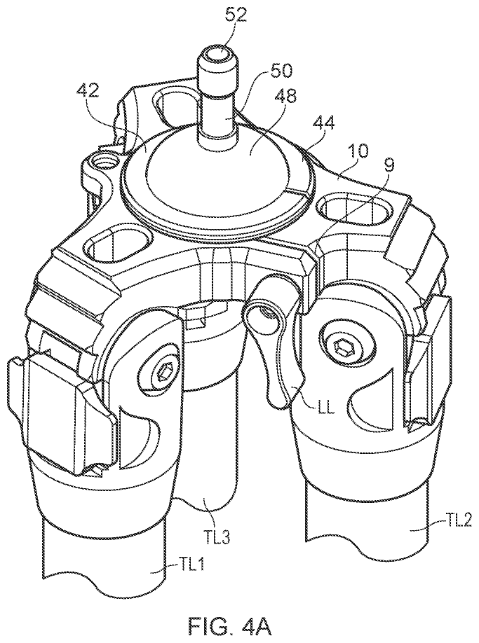

A ball head-type functional module 40 is shown in FIG. 4. This is an alternative functional module for use with a tripod chassis and includes a ball element as described below. The module 40 comprises a substantially circular collar 42 which is formed of plastics material and shaped to provide an upper peripheral rim 44 and a gap 46. The collar 42 also defines a recess 47 (obscured in FIG. 4). The collar surrounds an aluminium ball 48 which is provided with or formed with or connected to an upwardly extending spigot 50, so that the ball 48 can rotate and or pitch. The spigot 50 includes a strong magnet 52, for example a neodymium magnet, at its tip.

In use, the ball head-type functional module 40 is fitted in the central aperture 14 of tripod chassis 10 as shown in FIG. 4A. The proximal tip of the resiliently biased locking pin (obscured in FIG. 4A) engages with the recess 47 to inhibit translational or rotational movement of the functional module 40 when inserted in the central aperture 14. A locking lever LL is provided which can be operated by a user to close the gap G further or alternatively inhibiting withdrawal (i.e., translational movement) or rotation (i.e., rotational movement) of the module 40.

A Tripod Assembly Including a Central Column Toolbox-Type Functional Module

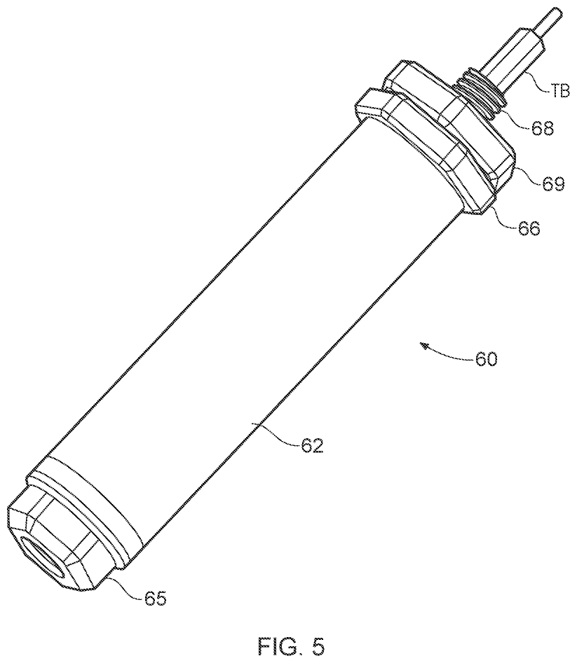

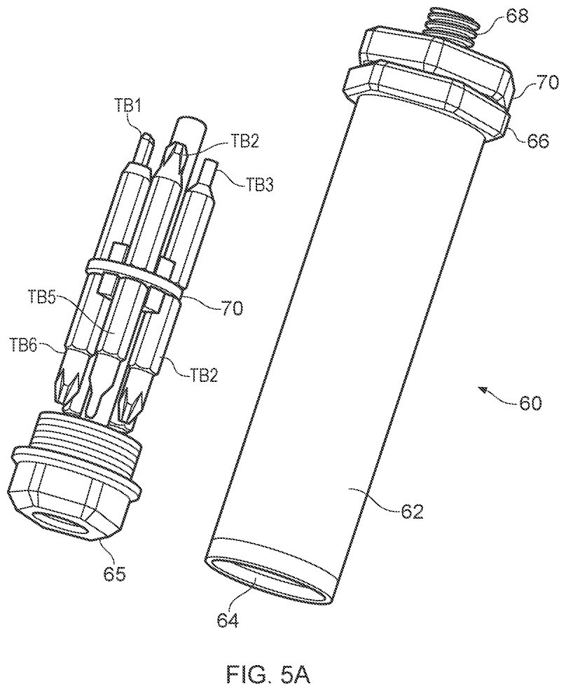

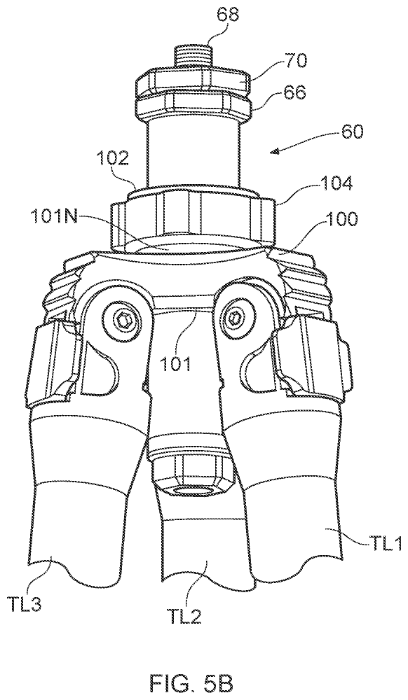

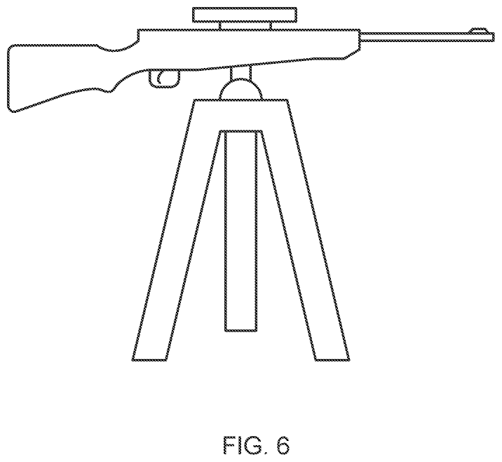

A central column toolbox-type functional module 60 is shown in FIGS. 5, 5A and 5B. This is another functional module for use with a tripod chassis. The module 60 comprises a lightweight tubular body 62 formed from, for example, carbon fibre although other materials such as aluminium are contemplated. Although a tubular body with a circular cross section is preferred, it will be appreciated by the skilled addressee that other forms are possible for the body for cooperating with a correspondingly shaped aperture in a tripod body such as rectangular cross section. A lower end of the body 62 is threaded at portion 64 to receive a removable correspondingly threaded lower cap 65. An upper end of the body 62 is fitted with a fixed upper cap 66. A screw 68 extends through the upper cap 66. The screw 68 has a conventional photographic standard threaded screw for fitting a camera, scope or other device i.e., it has a ⅜-16 UNC or ¼-20 UNC thread. A rotatable locking collar 69 is fitted on screw 68 and extends beyond the periphery of the tubular body 62 to inhibit movement of the module 60 through a tripod chassis. The exposed end of the screw 68 defines a central hexagonal bore for receiving a hexagonal tool bit TB as shown in FIG. 5. The central hexagonal bore may contain a magnetic element for attracting and retaining a ferrous tool bit. Alternatively, or additionally, the bore may include a detent or other means for releasably retaining a tool bit in the bore.

The lower cap 65 is fitted with a tool support 70, which holds and supports a plurality of tool components in a releasable manner. In the example shown, the tool components include several tool bits TB 1-6 which clip to the support 70. Other manners of connection are contemplated for example using magnetic attraction, or apertures for receiving the tool components. Allen-type key or “hex” bits are shown in FIG. 5A as representative tool components. It will be appreciated that many other types of bits may be provided or used, such as screwdriver, Torx driver or other bits according to the application. For most applications, a combination of screwdriver and hex key bits will be most useful for a user.

Although the tool support 70 is described above as being internal to the tubular column body 62, at least one tool component may be supported at the exterior of, or otherwise external to the column body 62. In this way the tool components may be more readily accessible to a user.

The lower cap 65 may be adapted for connection to other elements. For example, the lower cap 65 may be bored to receive a hook for suspending a weight—such as a camera bag—below the tripod chassis, in conventional manner, to stabilise the tripod assembly. Alternatively, or additionally the lower cap may include a threaded bore for receiving a threaded element. For example, the threaded bore may be dimensioned and threaded to receive a standard photographic screw for attaching other photographic devices, or to receive the screw 68.

In use, in connection with a tripod assembly, the central column toolbox-type functional module 60 is fitted in the central aperture of a tripod chassis 100. The tripod chassis 100 differs from the chassis 10 described above as it is intended to provide a lighter, simpler design which may be more suitable for certain applications. Notably, the body of the aluminium chassis 100, defines a central circular aperture 101 within an upwardly extending threaded tubular neck 101N which receives a tubular, longitudinal split plastics material locking insert 102 (obscured in FIG. 5B). The chassis 100 is smaller than the chassis 10 and does not have a gap G. Either or both of the neck 101N and insert 102 may be tapered to improve co-operation. Instead of a resiliently biased locking pin to inhibit movement of an inserted functional module, the chassis 100 is provided with a threaded locking collar 104, which is concentric with the central aperture 101 which cooperates with the correspondingly—threaded locking neck 101N and locking insert 102 to tighten on the tubular body 62 of the central column tool box module 60, when the collar 104 is screwed down, inhibiting withdrawal (i.e., translational movement) or rotation (i.e., rotational movement) of the module 60. Conversely, the grip on the central column toolbox module 60 is reduced when the locking collar 104 is unscrewed from the threaded neck 101N.

It will be appreciated by the skilled addressee that the central column toolbox-type functional module 60 could be fitted in the central aperture of a tripod chassis such as tripod chassis 10 described above in relation to other functional modules. A recess could be provided in the wall of the tubular body to engage with the locking pin forming a locking means of such a tripod chassis type.

In normal use, the central column toolbox-type functional module is located within the tripod chassis 100 as described above and can be used to support a photographic device such a camera or tripod head on the screw 68 in conventional manner. Alternatively, the screw 68 could engage with another device having a threaded portion designed to engage with a photographic type standard screw such as that of the applicant's DAVROS head. In this latter way, a firearm can be mounted on the tripod assembly. Rotation of a device attached to the screw 68 may be inhibited in conventional manner by rotation of the locking collar 69 so that the collar 69 moves outwardly along the screw 68 to engage with a surface of the device.

When required the central column toolbox-type functional module 60 can be detached from the tripod chassis 100 so that a user can remove a tool component such as a bit from the support 70, insert the tool bit in the central hexagonal bore of the screw 68 (as shown in FIG. 5) and use the tubular body 62 as a tool handle. In other words, the body 62 and tool bit together in the functional condition shown in FIG. 5 become a convenient tool for adjusting or repairing equipment.

It will be appreciated that a user can utilise the central column toolbox-type functional module 60 as a lightweight, portable and convenient tool container and tool independently of its function in the context of a tripod assembly.

A Lifting Device Functional Module

Another functional module that can be used with a tripod chassis according to the disclosure comprises a lifting device such as a block and tackle. The functional module in this embodiment comprises a body which is received in the central aperture of the tripod chassis, between connected tripod legs in a tripod assembly generally as described above in relation to other functional modules. The body of this functional module supports a block and tackle arrangement below the body of the functional module such that the block and tackle can be used to support and lift a payload below the tripod. This may be convenient to a user for example to allow kit to be lifted up a gap in rocks when climbing.

1. A tripod assembly for supporting an object, the tripod assembly comprising:
a tripod chassis body which is supportable above a surface by a plurality of tripod legs which are arranged, in use, below the chassis body, the chassis body defining a central aperture between the tripod legs,
a functional module selected from a plurality of functional modules having a body which fits in the central aperture, and
locking means for locking the functional module, which has been located in the central aperture, whereby the selected functional module can be replaced by another functional module selected from the plurality of functional modules, in which
the selected functional module is a first functional module which includes a movable ball element, and an object-engaging element; or the selected functional module is a functional module which includes a lifting device for supporting or lifting an object below the tripod; or the selected functional module is a functional module which comprises a central tripod column containing or otherwise supporting at least one tool component.

2. A tripod assembly according to claim 1, in which the aperture is circular.

3. A tripod assembly according to claim 2 in which the body of the selected functional module has a circular portion which is received within the circular aperture.

4. A tripod assembly according to claim 3 in which the body of the functional module includes a peripheral rim for inhibiting movement of the functional module through the central aperture.

5. A tripod assembly according to claim 1 in which the functional module is arranged to engage with the locking means.

6. A tripod assembly according to claim 1 in which the selected functional module object engaging element forms a spigot

7. A tripod assembly according to claim 6 in which the spigot is magnetic or capable of magnetic attraction to the object, or to an element mounted on the object.

8. A tripod assembly according to claim 1 and in which the selected functional module includes a ball element, in which locking means is provided for locking the ball element in one of a number of orientations.

9. A tripod assembly according to claim 8 in which the ball element can be retained in a specific orientation, by locking means provided by the tripod chassis.

10. A tripod assembly according to claim 9 in which the ball element includes an object engagement element, such as a spigot.

11. A tripod assembly according to claim 1 in which the functional module comprises a central tripod column containing or otherwise supporting at least one tool component.

12. A tripod assembly according to claim 1 in which the functional module comprises a lifting device including a block and tackle.

13. A tripod assembly according to claim 1 and including an insert arranged within the central aperture between the tripod chassis and the selected functional module.

14. A tripod chassis for use in a tripod assembly according to claim 1, the tripod chassis comprising:
a chassis body which is supportable by a plurality of tripod legs which are arranged, in use, below the chassis body, the chassis body defining a central aperture for receiving a functional module in use; and
at least one locking means for locking a functional module which has been located in the central aperture to inhibit rotational and/or translational movement of the so located functional module.

15. A tripod chassis according to claim 14 in which the locking means inhibits rotational and translational movement of a functional module arranged in the central aperture.

16. A tripod chassis including two or more locking means for inhibiting rotational and translational movement of a functional module arranged in the central aperture.

17. A tripod chassis according to claim 14 in which the central aperture is circular, and dimensioned to receive a correspondingly shaped body of a selected functional module.

18. A tripod comprising a tripod assembly for supporting an object or a tripod chassis,
the tripod assembly comprising:
a tripod chassis body which is supportable above a surface by a plurality of tripod legs which are arranged, in use, below the chassis body, the chassis body defining a central aperture between the tripod legs,
a functional module selected from a plurality of functional modules having a body which fits in the central aperture, and
locking means for locking the functional module, which has been located in the central aperture, whereby the selected functional module can be replaced by another functional module selected from the plurality of functional modules, in which the selected functional module is a first functional module which includes a movable ball element, and an object-engaging element; or the selected functional module is a functional module which includes a lifting device for supporting or lifting an object below the tripod; or the selected functional module is a functional module which comprises a central tripod column containing or otherwise supporting at least one tool component,
the tripod chassis comprising:
a chassis body which is supportable by a plurality of tripod legs which are arranged, in use, below the chassis body, the chassis body defining a central aperture for receiving a functional module in use; and
at least one locking means for locking a functional module which has been located in the central aperture to inhibit rotational and/or translational movement of the so located functional module.

19. A combination of a tripod according to claim 18 and a tripod head unit selected from the group consisting of a standard ball head, a fluid head unit, and a head unit according to U.S. Pat. No. 10,808,880.

20. A combination according to claim 19 and a firearm for supporting on the tripod.

21. A modular system comprising a tripod chassis according to claim 14 and at least two of items selected from the group consisting of tripod legs, and functional modules as described herein.

22. A modular system according to claim 21 in which the functional modules are selected from the group consisting of a ball element, a flat upper surface, and a lifting device, a tripod central column including at least one tool component.

23. A tripod central column including tool containing means for containing or otherwise holding at least one tool component.

24. A tripod central column according to claim 23 including means for containing or otherwise holding a plurality of tool components.

25. A tripod central column according to claim 23 in which the means for containing or otherwise holding at least one tool component is internal to the column.

26. A tripod central column according to claim 23 including a screw element for engaging a device such as a photographic device such as a camera or lens or a tripod head unit and in which the screw element is arranged to hold a tool component.

27. A tripod central column according to claim 26 in which the screw element includes a portion shaped to receive a correspondingly shaped tool component.

28. A tool formed by a tripod central column according to claim 26 forming a user grippable tool handle and a tool component held by the screw element.

29. A tripod assembly comprising a tripod central column according to claim 23 and at least one tripod assembly component selected from the group consisting of a tripod chassis, a tripod leg, a tool component, and a tripod head unit.
